(19) United States
(12) Patent Application Publication
(10) Pub. No.: US 2021/0182812 A1
(43) Pub. Date: Jun. 17, 2021

(54) METHOD, SYSTEM, AND NON-TRANSITORY COMPUTER READABLE RECORD MEDIUM TO PROCESS PAYMENTS USING PAYMENT-ONLY CART

(71) Applicant: LINE Plus Corporation, Seongnam-si (KR)

(72) Inventors: Youngsub PARK, Seongnam-si (KR); Jae Yun JUNG, Seongnam-si (KR); Seo Yeon LEE, Seongnam-si (KR)

(73) Assignee: LINE Plus Corporation, Seongnam-si (KR)

(21) Appl. No.: 17/119,144

(22) Filed: Dec. 11, 2020

(30) Foreign Application Priority Data
Dec. 12, 2019 (KR) 10-2019-165355

(51) Int. Cl. G06Q 20/10; G06Q 20/40; G06Q 20/38; G06Q 20/12

(52) U.S. Cl. CPC G06Q 20/102; G06Q 20/12; G06Q 20/384; G06Q 20/4014

(57) ABSTRACT

Disclosed is a method, system, and non-transitory computer-readable record medium for processing a payment. The payment method includes receiving a payment request corresponding to a first user from a server and storing the payment request in a payment cart corresponding to a second user selected by the first user; providing a payment request list indicating the payment request stored in the payment cart to an electronic device of the second user based on a first request corresponding to the second user; and processing a payment for at least one payment request selected by the second user from the payment request list based on a second request the second user.

### CROSS-REFERENCE TO RELATED APPLICATION

This application claims priority to Korean Patent Application No. 10-2019-0165355, filed Dec. 12, 2019 in the Korean Intellectual Property Office, the disclosure of which is incorporated herein by reference in its entirety.

### BACKGROUND

### 1. Field

Apparatuses, systems, and methods according to example embodiments of the following description relate to technology for collecting and processing payment requests using a payment-only cart.

### 2. Description of Related Art

With the rapid spread of the Internet, the sale and purchase of products through the Internet are expanding and shopping malls selling various products are on the rapid increase accordingly.

In this manner, an online shopping field through the Internet develops and various payment solutions are being introduced accordingly.

In the related art, an online payment may be made with a real card by connecting a card reader capable of reading a credit card to a smartphone.

### SUMMARY

Example embodiments may batch-process a plurality of payment requests using a payment-only cart.

Example embodiments may easily process a payment requested by another user using a payment-only cart.

According to an aspect of an example embodiment, there is provided a payment method including receiving a payment request corresponding to a first user from a server and storing the payment request in a payment cart corresponding to a second user selected by the first user; providing a payment request list indicating the payment request stored in the payment cart to an electronic device of the second user based on a first request corresponding to the second user; and processing a payment for at least one payment request selected by the second user from the payment request list based on a second request the second user.

The payment request may include a transaction identifier (ID) created at the server and identification information of the second user.

The payment request may include information selected by the first user that corresponds to the payment request.

The payment method may further include: authenticating the first user using a social network service (SNS) platform based on an authentication request for the first user received from the server.

The second user may be selected by the first user using an SNS friend list of the first user.

The payment method may further include: providing a message about the payment request to a chatroom that comprises the first user and the second user.

The payment request may be one among a plurality of payment requests indicated by the payment request list, and the providing may include distinguishably displaying at least one of the plurality of payment requests from another one of the plurality of payment requests based on a time at which the one of the plurality of payment requests was stored in the payment cart.

The payment method may further include: deleting a payment request corresponding to a delete request from the payment cart based on the delete request being received from the server.

The providing may include providing any one or any combination of link information indicating the server and items corresponding to the payment request based on a payment cart inquiry request received from the electronic device of the second user based on a selection on the payment request of the first user from the payment request list.

The payment method may further include: authenticating the first user through using a social network service (SNS) platform based on an authentication request for the first user received from the server, wherein the providing may include displaying the payment request list with an SNS profile of the first user corresponding to the payment request in the payment request list.

The payment request may include information selected by the first user that corresponds to the payment request, and the processing may include, based on the payment for the payment request being completed, sending, to the server, a payment completion notification that comprises the transaction ID corresponding to the payment request for which the payment is completed.

According to an aspect of an example embodiment, there is provided a non-transitory computer-readable record medium storing instructions that, when executed by a processor, cause the processor to implement a payment method including: receiving a payment request corresponding to a first user from a server and storing the payment request in a payment cart corresponding to a second user selected by the first user; providing a payment request list indicating the payment request stored in the payment cart to an electronic device of the second user based on a first request corresponding to the second user; and processing a payment for at least one payment request selected by the second user from the payment request list based on a second request corresponding to the second user.

According to an aspect of an example embodiment, there is provided a computer apparatus including: at least one memory configured to store computer-readable instructions; and at least one processor configured to execute the computer-readable instructions to: receive a payment request corresponding to a first user from a server and to store the payment request in a payment cart corresponding to a second user selected by the first user; provide a payment request list indicating the payment request stored in the payment cart to an electronic device of the second user based on a first request corresponding to the second user; and process a payment for at least one payment request selected by the second user from the payment request list based on a second request corresponding to the second user.

The payment request may include a transaction identifier (ID) created at the server and identification information of the second user.

The at least one processor may be further configured to execute the computer-readable instructions to authenticate the first user using a social network service (SNS) platform based on an authentication request for the first user received from the server, and the second user may be selected by the first user using an SNS friend list of the first user.

The at least one processor may be further configured to send a message about the payment request to a chatroom that comprises the first user and the second user.

The payment request may be one among a plurality of payment requests indicated by the payment request list, and the at least one processor may be further configured to execute the computer-readable instructions to distinguishably display at least one of the plurality of payment requests from another one of the plurality of payment requests based on a time at which the one of the plurality of payment requests was stored in the payment cart.

The at least one processor may be further configured to execute the computer-readable instructions to delete a payment request corresponding to a delete request from the payment cart based on the delete request being received from the server.

The at least one processor may be further configured to execute the computer-readable instructions to authenticate the first user using a social network service (SNS) platform based on an authentication request for the first user received from the server, the second user may be selected by the first user using an SNS friend list of the first user, and the at least one processor may be further configured to execute the computer-readable instructions to display the payment request list with an SNS profile of the first user corresponding to the payment request in the payment request list.

The at least one processor may be further configured to execute the computer-readable instructions to, based on the payment for the payment request of the first user being completed, send, to the server, a payment completion notification that comprises the transaction ID corresponding to the payment request for which the payment is completed.

### BRIEF DESCRIPTION OF THE FIGURES

The above and/or other aspects will be more apparent by describing certain example embodiments, with reference to the accompanying drawings, in which:

FIG. 1 is a diagram illustrating an example of a network environment according to at least one example embodiment;

FIG. 2 is a diagram illustrating an example of an electronic device and a server according to at least one example embodiment;

FIG. 3 is a diagram illustrating an example of components included in a processor of a server according to at least one example embodiment;

FIG. 4 is a flowchart illustrating an example of a method performed by a server according to at least one example embodiment;

FIG. 5 illustrates an example of a data flow of a payment method using a payment cart according to at least one example embodiment;

FIG. 6 illustrates an example of an interface screen of providing a notification message about a payment request according to at least one example embodiment;

FIG. 7 illustrates an example of an interface screen of providing a payment application according to at least one example embodiment;

FIGS. 8 and 9 illustrate examples of an interface screen of providing a payment request list stored in a payment cart according to at least one example embodiment;

FIG. 10 illustrates an example of an interface screen of providing a notification message about a payment completion according to at least one example embodiment; and

FIG. 11 illustrates another example of a data flow of a payment method using a payment cart according to at least one example embodiment.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer record medium or device, capable of providing instructions or data to, or being interpreted by, a hardware device. The software also may be distributed over network coupled computer systems so that the software is stored and executed in a distributed fashion. In particular, for example, software and data may be stored by one or more computer readable record mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable record medium into the one or more storage devices and/or one or more computer processing devices using a drive mechanism. Such separate computer readable record medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable record medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

The example embodiments relate to technology for collecting and processing payment requests using a payment-only cart.

The example embodiments including the disclosures described herein may easily and effectively process a payment requested by a corresponding user or another user using a payment-only cart.

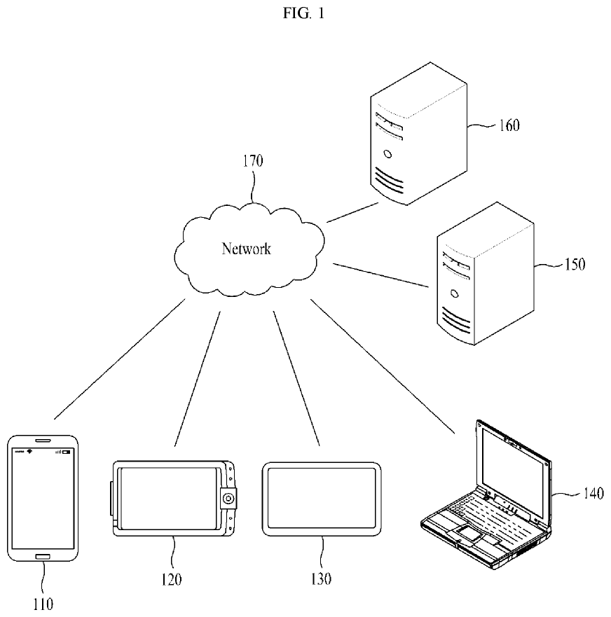

FIG. 1 illustrates an example of a network environment according to at least one example embodiment. Referring to FIG. 1, the network environment may include a plurality of electronic devices 110, 120, 130, and 140, a plurality of servers 150 and 160, and a network 170. FIG. 1 is provided as an example only. A number of electronic devices or a number of servers is not limited thereto.

Each of the plurality of electronic devices 110, 120, 130, and 140 may be a stationary terminal or a mobile terminal that is configured as a computer system. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, a game console, a wearable device, an Internet of things (IoT) device, a virtual reality (VR) device, an augmented reality (AR) device, and the like. For example, although FIG. 1 illustrates a shape of a smartphone as an example of the electronic device 110, the electronic device 110 used herein may refer to one of various types of physical computer systems capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, a broadcasting network, a satellite network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer apparatus or a plurality of computer apparatuses that provides an instruction, a code, a file, content, a service, etc., through communication with the plurality of electronic devices 110, 120, 130, and 140 over the network 170. For example, the server 150 may be a system that provides a first service to the plurality of electronic devices 110, 120, 130, and 140 connected over the network 170. The server 160 may be a system that provides a second service to the plurality of electronic devices 110, 120, 130, and 140 connected over the network 170. In detail, the server 150 may provide, as the first service, a service (e.g., a payment service) intended by an application through the application as a computer program installed and executed on the plurality of electronic devices 110, 120, 130, and 140. As another example, the server 160 may provide, as the second service, a service that distributes a file for installing and executing the application to the plurality of electronic devices 110, 120, 130, and 140.

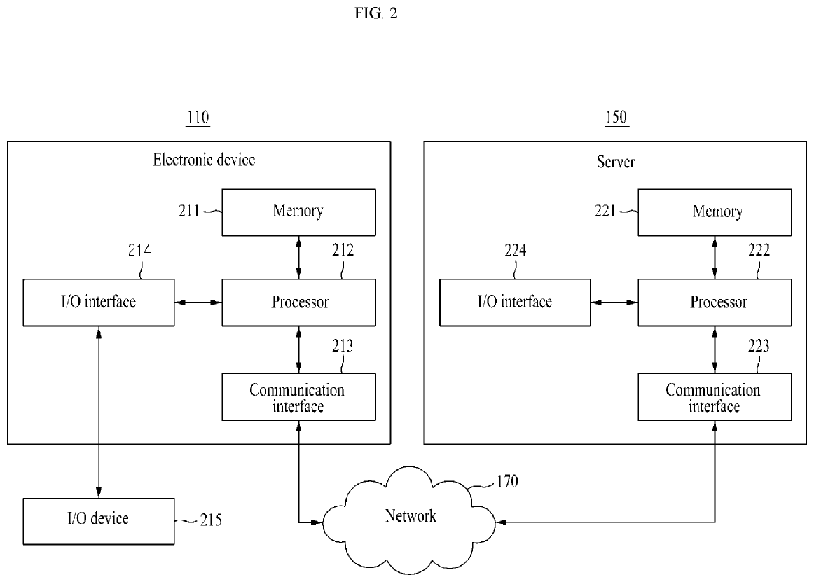

FIG. 2 is a block diagram illustrating an example of an electronic device and a server according to at least one example embodiment. Description is made using the electronic device 110 as an example of an electronic device and the server 150 as an example of a server with reference to FIG. 2. Also, the other electronic devices 120, 130, and 140 or the server 160 may have the same or similar configuration as that of the electronic device 110 or the server 150.

Referring to FIG. 2, the electronic device 110 may include a memory 211, a processor 212, a communication interface 213, and an input/output (I/O) interface 214, and the server 150 may include a memory 221, a processor 222, a communication interface 223, and an I/O interface 224. The memory 211, 221 may include a permanent mass storage device, such as random access memory (RAM), a read only memory (ROM), a disk drive, a solid state drive (SSD), a flash memory, etc., as a non-transitory computer-readable record medium. The permanent mass storage device, such as ROM, SSD, flash memory, and disk drive, may be included in the electronic device 110 or the server 150 as a permanent storage device separate from the memory 211, 221. Also, an OS and at least one program code, for example, a code for a browser installed and executed on the electronic device 110 or an application installed and executed on the electronic device 110 to provide a specific service, may be stored in the memory 211, 221. Such software components may be loaded from another non-transitory computer-readable record medium separate from the memory 211, 221. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 211, 221 through the communication interface 213, 223, instead of the non-transitory computer-readable record medium. For example, at least one program may be loaded to the memory 211, 221 based on a computer program, for example, the application, installed by files provided over the network 170 from developers or a file distribution system, for example, the server 160, providing an installation file of the application.

The processor 212, 222 may be configured to process instructions of a computer program by performing basic arithmetic operations, logic operations, and I/O operations. The computer-readable instructions may be provided from the memory 211, 221 or the communication interface 213, 223 to the processor 212, 222. For example, the processor 212, 222 may be configured to execute received instructions in response to the program code stored in the storage device, such as the memory 211, 221.

The communication interface 213, 223 may provide a function for communication between the electronic device 110 and the server 150 over the network 170 and may provide a function for communication between the electronic device 110 and/or the server 150 and another electronic device, for example, the electronic device 120 or another server, for example, the server 160. For example, the processor 212 of the electronic device 110 may transfer a request created based on a program code stored in the storage device such as the memory 211, to the server 150 over the network 170 under control of the communication interface 213. A control signal, an instruction, content, a file, etc., provided under control of the processor 222 of the server 150 may be received at the electronic device 110 through the communication interface 213 of the electronic device 110 via the communication interface 223 and the network 170. For example, a control signal, an instruction, content, a file, etc., of the server 150 received through the communication interface 213 may be transferred to the processor 212 or the memory 211, and content, a file, etc., may be stored in a storage medium, for example, the permanent storage device, further includable in the electronic device 110.

The I/O interface 214 may be a device used for interface with an I/O apparatus 215. For example, an input device may include a device, such as a keyboard, a mouse, a microphone, a camera, etc., and an output device may include a device, such as a display, a speaker, a haptic feedback device, etc. As another example, the I/O interface 214 may be a device for interface with an apparatus in which an input function and an output function are integrated into a single function, such as a touchscreen. The I/O apparatus 215 may be configured as a single device with the electronic device 110. Also, the I/O interface 224 of the server 150 may be a device for interface with an apparatus (not shown) for input or output that may be connected to the server 150 or included in the server 150. In detail, when the processor 212 of the electronic device 110 processes an instruction of a computer program loaded to the memory 211, content or a service screen configured based on data provided from the server 150 or the electronic device 120 may be displayed on the display through the I/O interface 214.

According to other example embodiments, the electronic device 110 and the server 150 may include a number of components greater than or less than a number of components shown in FIG. 2. However, there is no need to clearly illustrate many components according to the related art. For example, the electronic device 110 may include at least a portion of the I/O apparatus 215, or may further include other components, for example, a transceiver, a global positioning system (GPS) module, a camera, a variety of sensors, a database (DB), and the like. In detail, if the electronic device 110 is a smartphone, the electronic device 110 may be configured to further include a variety of components, for example, an acceleration sensor, a gyro sensor, a camera module, various physical buttons, a button using a touch panel, an I/O port, a vibrator for vibration, etc., which are generally included in the smartphone.

Hereinafter, example embodiments of a method and system for processing a payment using a payment-only cart are described.

A proxy payment solution allows another user to pay for a product a user desires to purchase at a shopping site. For example, a payment request mail may be sent to a proxy payer and the proxy payer may make a proxy payment using the payment request mail.

The proxy payment has some limitations and inconveniences in that only one payment at a time needs to be processed immediately within a short period of time for each shopping site.

Example embodiments provide a payment solution that may collect and pay a plurality of payment requests in a batch manner at a single shopping site or a plurality of different shopping sites.

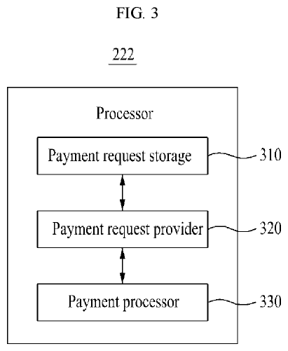

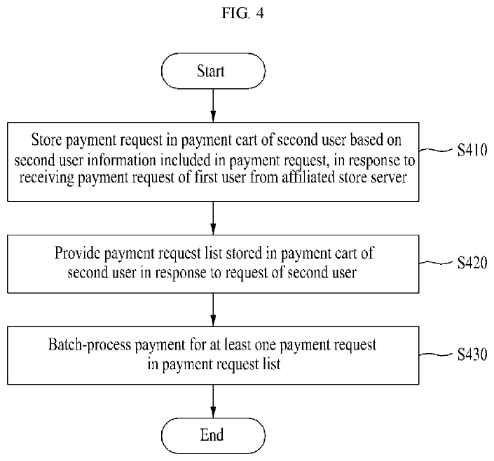

FIG. 3 is a diagram illustrating an example of components included in a processor of a server according to at least one example embodiment, and FIG. 4 is a flowchart illustrating an example of a method performed by a server according to at least one example embodiment.

The server 150 according to the example embodiment serves as a payment server that provides an electronic payment service. In particular, the server 150 may process a payment requested by a user or by another user using a payment-only cart.

Referring to FIG. 3, to perform a payment method of FIG. 4, the processor 222 of the server 150 may include a payment request storage 310, a payment request provider 320, and a payment processor 330. Depending on example embodiments, the components of the processor 222 may be selectively included in or excluded from the processor 222. Also, depending on example embodiments, the components of the processor 222 may be separated or merged for representations of functions of the processor 222.

The processor 222 and the components of the processor 222 may control the server 150 to perform operations S410 to S430 included in the payment method of FIG. 4. For example, the processor 222 and the components of the processor 222 may be configured to execute an instruction according to a code of at least one program and a code of an OS included in the memory 221.

Here, the components of the processor 222 may be representations of different functions of the processor 222 performed by the processor 222 in response to an instruction provided from the program code stored in the server 150. For example, the payment request storage 310 may be used as a functional representation of the processor 222 that controls the server 150 to store a payment request in response to the instruction.

The processor 222 may read a necessary instruction from the memory 221 to which instructions associated with control of the server 150 are loaded. In this case, the read instruction may include an instruction for controlling the processor 222 to perform the following operations S410 to S430.

Referring to FIG. 4, in operation S410, the payment request storage 310 may receive a payment request of a user (e.g., a user of the electronic device 110) (hereinafter, also referred to as a “first user”) that desires to make a purchase at a corresponding affiliated store from a service server corresponding to an affiliated store (hereinafter, referred to as an “affiliated store server”). Here, based on information about a user (e.g., a user of the electronic device 120) (hereinafter, also referred to as a “second user”) to perform an actual payment instead of the first user according to a payment request of the first user, the payment request storage 310 may identify the second user and then may store the received payment request in a payment cart that serves as a storage box associated with the second user. That is, the payment request from the first user may include identification information of the second user specified in response to a selection made by the first user for a proxy payment, and the payment request storage 310 may identify the second user based on the identification information of the second user included in the payment request and then may store the payment request in a payment cart of the identified second user.

The payment request may include purchase wish information that includes product information, price information, and quantity information of a product the first user desires to purchase. Here, in addition to essential information (e.g., price information) required for a payment in the purchase wish information, only a portion corresponding to a selection or an input of the first user may be included in the payment request as additional information. For example, when the first user requests the second user to make a payment, the first user may input purchase wish information excluding product information to be included in the payment request such that the product information may not be disclosed to the second user. In particular, the payment request may include a transaction identifier (ID) created at the affiliated store server in association with the purchase wish information of the first user. The payment request may include information used to identify the first user and may further include information used to identify the affiliated store server.

Here, the server 150 may receive an authentication request for the first user from the affiliated store server before the payment request of the first user. In response to the authentication request, authentication of the first user may be performed on the server 150 or SNS authentication of the first user may be performed through interaction with an SNS platform associated with the server 150. The payment request storage 310 may store, in the payment cart of the second user, the payment request of the first user that is successfully authenticated based on the authentication result of the first user, for example, the SNS authentication result of the first user. Identification information of the first user and the second user included in the payment request may be identification information on the SNS.

Also, the processor 222 may store the payment request of the first user in the payment cart of the second user and may also send a notification message about the payment request of the first user to a chatroom that includes the first user and the second user, for example, a one-to-one chatroom between the first user and the second user through interaction with the SNS platform associated with the server 150.

Although the example embodiment describes the second user as another user different from the first user, the second user may be at least one other user different from the first user. Depending on example embodiments, the first user and the second user may be the same user, i.e., an identical user. For example, one or more other users may request the second user to pay for purchase items the one or more other users desire at a plurality of affiliated stores. Alternatively, a single user may request the user himself or herself to pay for the purchase items the user desires at the plurality of affiliated stores.

In operation S420, in response to an inquiry request of the second user for the payment cart, the payment request provider 320 may provide a payment request list stored in the payment cart of the second user to the electronic device 120 of the second user. The payment cart of the second user may include a payment request received from at least one affiliated store server by at least one first user. In response to receiving the inquiry request for the payment cart from the second user, the payment request provider 320 may display the payment request list that includes payment requests stored in the payment cart of the second user.

For example, the payment request provider 320 may sort and display payment requests included in the payment request list in an ascending or descending order based on a time at which a corresponding payment request is received. As another example, the payment request provider 320 may distinguishably display at least a portion of payment requests stored in the payment cart of the second user. For example, the payment request provider 320 may display a payment request stored within a predetermined (or, alternatively, desired) period of time based on a point in time at which a corresponding inquiry is requested. Here, if the predetermined (or, alternatively, desired) period of time elapses after a payment request is stored in the payment cart, the corresponding payment request may be automatically deleted from the payment cart. In response to receiving, from the affiliated store server, a delete request of the first user that requests a corresponding payment for the payment request stored in the payment cart of the second user, the payment request provider 320 may delete a payment request corresponding to the delete request from the payment cart. As another example, the payment request provider 320 may classify and thereby display payment requests stored in the payment cart for each first user. If the payment cart includes payment requests received from a plurality of different users, the payment request provider 320 may classify and thereby display the payment requests for each user. As another example, in the case of displaying a payment request list, the payment request provider 320 may also display an SNS profile of the first user sending a corresponding payment request for each payment request through interaction with the SNS platform associated with the server 150.

In response to a selection of the second user on a specific payment request from the payment request list, the payment request provider 320 may provide a link to an affiliated store server corresponding to the specific payment request or may provide purchase wish information of the first user included in the specific payment request.

In operation S430, the payment processor 330 may batch-process a payment for at least one payment request included in the payment request list stored in the payment cart in response to the request of the second user. The payment processor 330 may batch-process the entire payment requests included in the payment request list of the payment cart or at least one payment request selected by the second user using a payment method of the second user. In the example embodiment, although different users send payment requests, or payment requests correspond to different purchase places, that is, an affiliated store server is different, the payment processor 330 may collect a plurality of payment requests associated with different users or different affiliated store servers in the payment cart and may batch-process the plurality of payment requests.

The payment processor 330 may send, to the affiliated store server, a payment completion notification representing that a payment for a corresponding payment request is completed. Here, the payment processor 330 may identify the affiliated store server based on information included in the payment request and may send the payment completion notification. Here, the payment completion notification may include a transaction ID corresponding to the corresponding payment request. The affiliated store server may verify purchase wish information for which the payment is completed based on the transaction ID included in the payment completion notification and may process a purchase for the purchase wish information as being completed. In addition, with respect to the payment request processed to be paid, the payment processor 330 may send a notification message about a payment completion to a chatroom that includes the first user sending the corresponding payment request and the second user processing the payment for the corresponding payment request, for example, a one-to-one chatroom between the first user and the second user.

Therefore, the example embodiment may collect a plurality of payment requests, each having a different sender of a payment request or shopping site in a payment cart and may batch-process the collected payment requests.

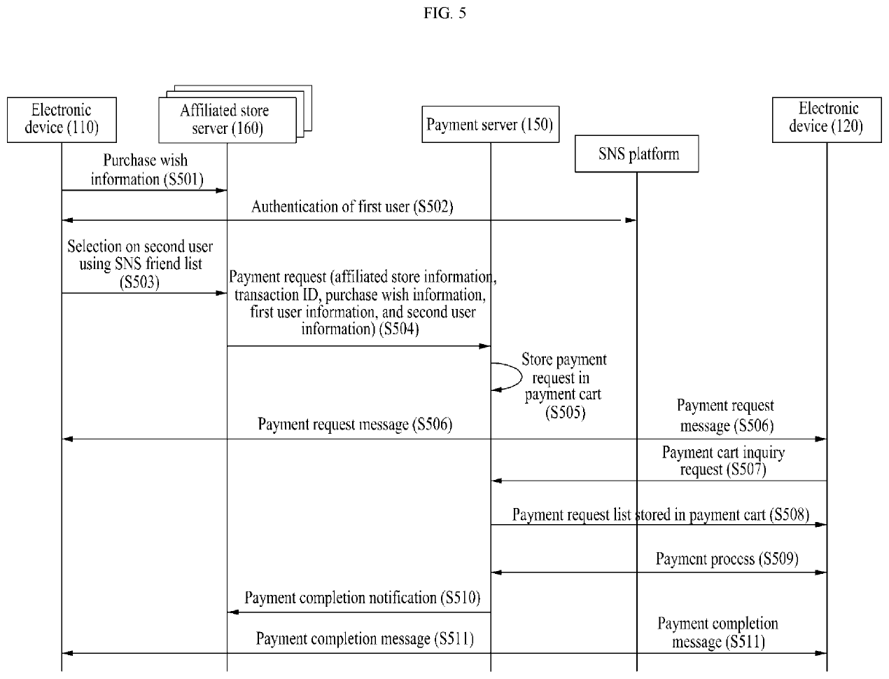

FIG. 5 illustrates an example of a data flow of a payment method using a payment cart according to at least one example embodiment.

Referring to FIG. 5, in operation S501, the server 160 (hereinafter, also referred to as the affiliated store server 160) that provides a shopping site may receive, from the electronic device 110 of the first user, purchase wish information that includes information about a product the first user desires to purchase, such as, for example, product information, price information, and quantity information, through the shopping site.

In operation S502, in response to a selection of the first user on a proxy payment as a payment type for the purchase wish information, the affiliated store server 160 may authenticate the first user based on SNS information through interaction with an SNS platform associated with the server 150 (hereinafter, also referred to as the payment server 150) through the payment server 150.

In operation S503, in response to successful authentication of the first user, the affiliated store server 160 may access an SNS friend list of the first user and may receive, from the first user, a selection on the second user the first user requests a payment of the purchase wish information using the SNS friend list of the first user.

The affiliated store server 160 may receive information about the second user selected by the first user together with the SNS authentication result of the first user in the operation S503.

In operation S504, in response to the selection of the first user on the second user and the SNS authentication result of the first use, the affiliated store server 160 may send the payment request of the first user to the payment server 150. Here, the payment request may include affiliated store information used to identify the affiliated store server 160, all of or a portion of the purchase wish information received in operation S501, a transaction ID created for the purchase wish information, first user information used to identify the first user, and/or second user information used to identify the second user.

Here, the affiliated store server 160 may receive a selection on information to be displayed for the second user in the purchase wish information received in operation S501 from the electronic device 110 of the first user and may include at least a portion of the purchase wish information, that is, information corresponding to the selection of the first user in the payment request.

In operation S505, in response to receiving, from the affiliated store server 160, the payment request of the first user that desires to make a purchase in a corresponding affiliated store, the payment server 150 may store the received payment request in a payment cart of the second user that is selected by the first user as a real payer.

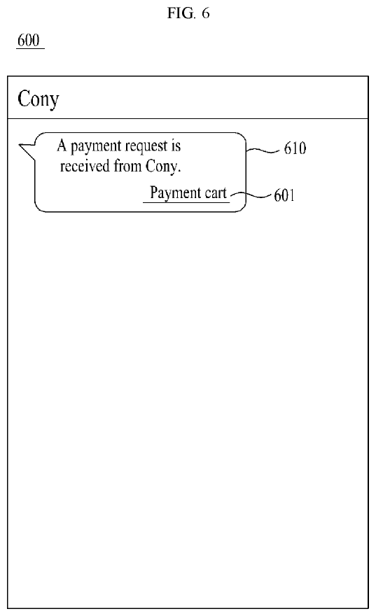

In operation S506, the payment server 150 may send a notification message about the payment request of the first user to a chatroom that includes the first user and the second user, for example, a one-to-one chatroom between the first user and the second user through interaction with the SNS platform associated with the payment server 150. For example, referring to FIG. 6, in response to “Cony” requesting “Brown” to pay for purchase wish information at a specific shopping site, a one-to-one chat screen 600 with “Cony” may be displayed on the electronic device 120 of “Brown.” Here, a payment request message 610 corresponding to a payment request of “Cony” may be displayed on the one-to-one chat screen 600 on the electronic device 120 of “Brown” as a received message. In response to purchase wish information of “Cony” being included and thereby disclosed in the payment request message 610 such that “Brown” may verify purchase wish content requested by “Cony” or in response to a selection on the payment request message 610 or a “Payment cart” menu 601, a popup that includes the purchase wish information of “Cony” may be displayed on the electronic device 120 of “Brown.” In this manner, information associated with the payment request between users may reinforce confidence about a payment process using an SNS-based chat interface.

Through the process including S501 to S505, the payment server 150 may store a plurality of payment requests each associated with a different user or affiliated store requesting the second user to pay in a payment cart of the second user.

Referring again to FIG. 5, in response to receiving a payment cart inquiry request from the electronic device 120 of the second user in operation S507, the payment server 150 may provide a payment request list stored in the payment cart of the second user to the electronic device 120 of the second user in operation S508.

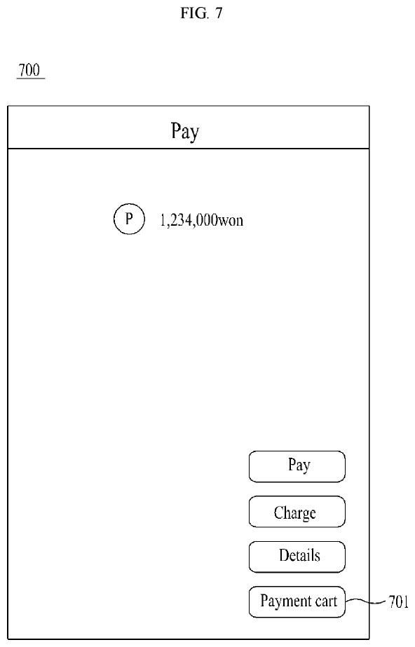

For example, referring to FIG. 6, in response to a selection of the second user on the “Payment cart” menu 601 included in the payment request message 610 on the one-to-one chat screen 600 with “Cony,” the electronic device 120 of the second user may send a payment cart inquiry request to the payment server 150. Also, referring to FIG. 7, in response to a selection of the second user on a “Payment cart” menu 701 included in a corresponding service screen 700 on the service screen 700 of an exclusive application associated with the payment server 150, the electronic device 120 of the second user may send a payment cart inquiry request to the payment server 150.

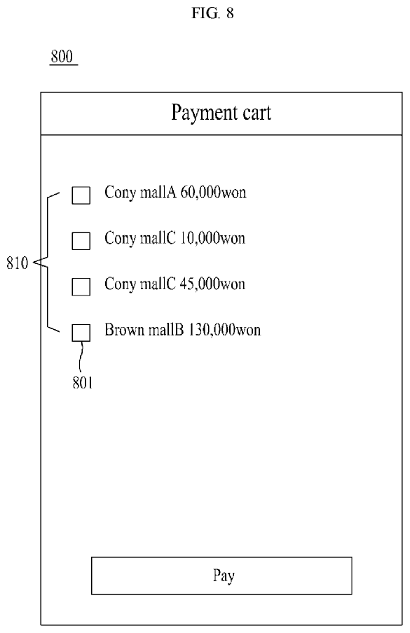

FIG. 8 illustrates an example of a payment cart screen 800 displayed on the electronic device 120 of “Brown.”

The payment cart screen 800 may include a payment request list 810 including payments for which “Brown” is requested to pay. Also, the payment request list 810 may include a payment for which another user requests “Brown” to pay through a plurality of shopping sites and a payment for which “Brown” requests himself to pay.

The payment request list 810 may include user information, affiliated store information and purchase amount information, and the like for each payment request and may include a selection box 801 for a selective payment. The second user may make a payment for each of the payment requests included in the payment request list 810 or at least one payment request selected through the selection box 801.

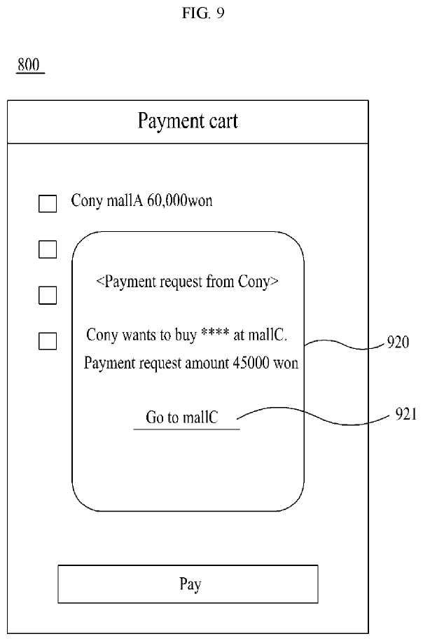

In response to a selection of the second user on a specific payment request from the payment request list 810, the electronic device 120 may provide a link to the affiliated store server 160 corresponding to the specific payment request or may provide purchase wish information of a first user included in the specific payment request. Referring to FIG. 9, in response to a selection of “Brown” on a specific payment request sent from “Cony” from the payment request list 810, the electronic device 120 may display a popup screen 920 that includes purchase wish information of “Cony.” The popup screen 920 may include a link 921 to the affiliated store server 160 corresponding to a desired purchase of “Cony.” Here, only a portion of information selected by “Cony” from the purchase wish information may be displayed. For example, in a process in which “Cony” sends a payment request to “Brown,” “Cony” may select price information to be included in the purchase wish information, and product information and quantity information to be excluded from the purchase wish information. In this case, only the price information selected by “Cony” may be displayed for “Brown.”

Referring again to FIG. 5, in operation S509, the payment server 150 may process a payment for at least one payment request from the payment request list stored in the payment cart in response to a request of the second user through interaction with the electronic device 120 of the second user. The payment server 150 may batch-process a payment for each of the entire payment requests included in the payment request list of the payment cart, or may batch-process a payment for at least one payment requests selected by the second user using a payment method of the second user in response to a selection of the second user.

In operation S510, the payment server 150 may send, to the affiliated store server 160, a payment completion notification representing that the payment for the payment request is completed. The payment server 150 may identify the affiliated store server 160 based on information included in the payment request and may send the payment completion notification to the corresponding affiliated store server 160. Here, the payment completion notification may include a transaction ID corresponding to the payment request. The affiliated store server 160 may verify the purchase wish information for which the payment is completed based on the transaction ID included in the payment completion notification and may process a purchase for the purchase wish information as being completed.

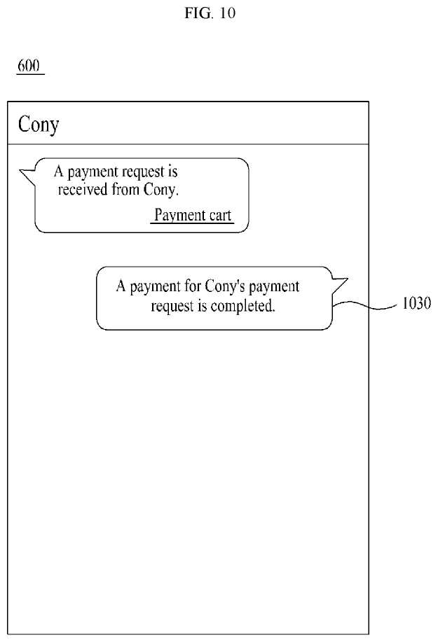

In operation S511, the payment server 150 may send a notification message about a payment completion to the chatroom that includes the first user and the second user, for example, the one-to-one chatroom between the first user and the second user through interaction with the SNS platform associated with the payment server 150. For example, referring to FIG. 10, in response to “Brown” completing a payment for the payment request sent from “Cony,” a payment completion message 1030 about the payment request of “Cony” may be displayed in a send message form on the one-to-one chat screen 600 with “Cony” on the electronic device 120 of “Brown.” In response to purchase wish information of “Cony” being included and thereby disclosed in the payment completion message 1030 to verify a payment request for which a payment is completed among payment requests or in response to a selection on the payment completion message 1030, a popup that includes the purchase wish information of “Cony” may be displayed.

Although it is discussed above that the notification messages in operation S511 indicates the payment completion, example embodiments are not limited thereto. For example, the notification message may indicate partial payment completion or payment rejection based on whether the second user selects only some of the payments in the payment cart for payment.

Therefore, the example embodiment may batch-process a plurality of payment requests using a payment cart on the payment server 150.

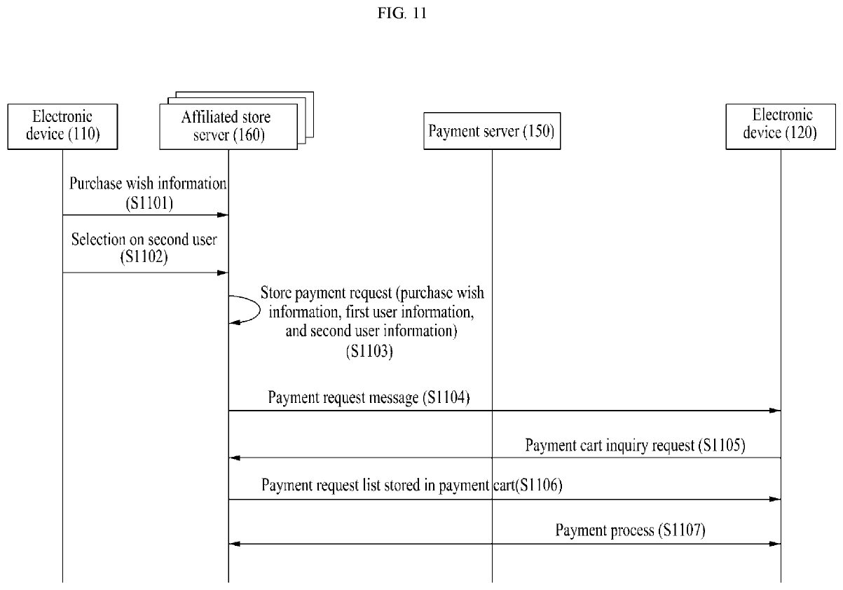

FIG. 11 illustrates another example of a data flow of a payment method using a payment cart according to at least one example embodiment.

Referring to FIG. 11, in operation S1101, the affiliated store server 160 that provides a shopping site may receive, from the electronic device 110 of the first user, purchase wish information that includes information about a product the first user desires to purchase, through the shopping site. For example, the purchase wish information may include information indicating product information, price information, and quantity information, through the shopping site.

In operation S1102, in response to a selection of the first user on a proxy payment as a payment type for the purchase wish information, the affiliated store server 160 may receive, from the first user, a selection on the second user the first user is to request a payment for the purchase wish information based on user information stored in the affiliated store server 160. For example, the second user may be selected by the first user based on user information stored in the affiliated store server 160, such as, for example, a shopping mall ID on a shopping site, an SNS ID associated with the shopping mall ID, and a telephone number associated with the shopping mall ID.

In operation S1103, in response to the selection of the first user on the second user being completed, the affiliated store server 160 may store the payment request of the first user in a payment cart of the second user selected by the first user as a real payer. The affiliated store server 160 may store the payment request received from the first user in the payment cart in a form of a storage box included in a personal page associated with the second user. Here, the payment request may include the purchase wish information received in operation S1101, first user information used to identify the first user, and/or second user information used to identify the second user.

Here, the affiliated store server 160 may receive, from the electronic device 110 of the first user, a selection on information to be displayed for the second user in the purchase wish information received in operation S1101 and may include at least a portion of the purchase wish information, that is, information corresponding to the selection of the first user in the payment request.

In operation S1104, the affiliated store server 160 may store the payment request of the first user in the payment cart of the second user and then may send a notification message about the payment request of the first user to the electronic device 120 of the second user. For example, the affiliated store server 160 may send the notification message about the payment request of the first user to the second user through the SNS platform or a text service platform, such as, a short message service (SMS). The notification message about the payment request may be provided as a call-back universal resource locator (URL) message that includes a link to the affiliated store server 160. Here, the notification message may include at least a portion of the purchase wish information of the first user, for example, partial information selected by the first user.

In response to receiving a payment cart inquiry request from the electronic device 120 of the second user in operation S1105, the affiliated store server 160 may provide a payment request list stored in the payment cart of the second user to the electronic device 120 of the second user in operation S1106. The second user may access the affiliated store server 160 through the notification message about the payment request and may verify the payment request list received from the affiliated store server 160.

In operation S1107, in response to the request of the second user, the affiliated store server 160 may process a payment for at least one payment request in the payment request list stored in the payment cart through interaction with the payment server 150. The affiliated store server 160 may verify the purchase wish information corresponding to the payment request for which the payment is processed and may process a purchase for the corresponding purchase wish information as being completed.

Therefore, example embodiments may batch-process a plurality of payment requests using a payment cart implemented as a personal storage box on the affiliated store server 160 that provides a shopping site.

As described above, according to some example embodiments, it is possible to improve payment convenience and efficiency by collecting and batch-processing a plurality of payment requests sent from a user or another user through a plurality of shopping sites using a payment-only cart.

The systems or the apparatuses described herein may be implemented using hardware components, software components, and/or a combination thereof. For example, a processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, computer record medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable record mediums.

The methods according to the above-described example embodiments may be configured in a form of program instructions performed through various computer devices and recorded in non-transitory computer-readable media. The media may also include, alone or in combination with the program instructions, data files, data structures, and the like. The media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software.

The foregoing embodiments are merely examples and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A payment method comprising:
receiving a payment request corresponding to a first user from a server and storing the payment request in a payment cart corresponding to a second user selected by the first user;
providing a payment request list indicating the payment request stored in the payment cart to an electronic device of the second user based on a first request corresponding to the second user; and
processing a payment for at least one payment request selected by the second user from the payment request list based on a second request the second user.

2. The payment method of claim 1, wherein the payment request comprises a transaction identifier (ID) created at the server and identification information of the second user.

3. The payment method of claim 2, wherein the payment request comprises information selected by the first user that corresponds to the payment request.

4. The payment method of claim 1, further comprising:
authenticating the first user using a social network service (SNS) platform based on an authentication request for the first user received from the server.

5. The payment method of claim 4, wherein the second user is selected by the first user using an SNS friend list of the first user.

6. The payment method of claim 4, further comprising:
providing a message about the payment request to a chatroom that comprises the first user and the second user.

7. The payment method of claim 1, wherein the payment request is one among a plurality of payment requests indicated by the payment request list, and
wherein the providing comprises distinguishably displaying at least one of the plurality of payment requests from another one of the plurality of payment requests based on a time at which the one of the plurality of payment requests was stored in the payment cart.

8. The payment method of claim 1, further comprising:
deleting a payment request corresponding to a delete request from the payment cart based on the delete request being received from the server.

9. The payment method of claim 1, wherein the providing comprises providing any one or any combination of link information indicating the server and items corresponding to the payment request based on a payment cart inquiry request received from the electronic device of the second user based on a selection on the payment request of the first user from the payment request list.

10. The payment method of claim 1, further comprising:
authenticating the first user through using a social network service (SNS) platform based on an authentication request for the first user received from the server,
wherein the providing comprises displaying the payment request list with an SNS profile of the first user corresponding to the payment request in the payment request list.

11. The payment method of claim 1, wherein the payment request comprises information selected by the first user that corresponds to the payment request, and
wherein the processing comprises, based on the payment for the payment request being completed, sending, to the server, a payment completion notification that comprises the transaction ID corresponding to the payment request for which the payment is completed.

12. A non-transitory computer-readable record medium storing instructions that, when executed by a processor, cause the processor to implement a payment method comprising:
receiving a payment request corresponding to a first user from a server and storing the payment request in a payment cart corresponding to a second user selected by the first user;
providing a payment request list indicating the payment request stored in the payment cart to an electronic device of the second user based on a first request corresponding to the second user; and
processing a payment for at least one payment request selected by the second user from the payment request list based on a second request corresponding to the second user.

13. A computer apparatus comprising:
at least one memory configured to store computer-readable instructions; and
at least one processor configured to execute the computer-readable instructions to:
receive a payment request corresponding to a first user from a server and to store the payment request in a payment cart corresponding to a second user selected by the first user;
provide a payment request list indicating the payment request stored in the payment cart to an electronic device of the second user based on a first request corresponding to the second user; and
process a payment for at least one payment request selected by the second user from the payment request list based on a second request corresponding to the second user.

14. The computer apparatus of claim 13, wherein the payment request comprises a transaction identifier (ID) created at the server and identification information of the second user.

15. The computer apparatus of claim 13, wherein the at least one processor is further configured to execute the computer-readable instructions to authenticate the first user using a social network service (SNS) platform based on an authentication request for the first user received from the server, and
wherein the second user is selected by the first user using an SNS friend list of the first user.

16. The computer apparatus of claim 15, wherein the at least one processor is further configured to send a message about the payment request to a chatroom that comprises the first user and the second user.

17. The computer apparatus of claim 13, wherein the payment request is one among a plurality of payment requests indicated by the payment request list, and
wherein the at least one processor is further configured to execute the computer-readable instructions to distinguishably display at least one of the plurality of payment requests from another one of the plurality of payment requests based on a time at which the one of the plurality of payment requests was stored in the payment cart.

18. The computer apparatus of claim 13, wherein the at least one processor is further configured to execute the computer-readable instructions to delete a payment request corresponding to a delete request from the payment cart based on the delete request being received from the server.

19. The computer apparatus of claim 13, wherein the at least one processor is further configured to execute the computer-readable instructions to authenticate the first user using a social network service (SNS) platform based on an authentication request for the first user received from the server,
wherein the second user is selected by the first user using an SNS friend list of the first user, and
wherein the at least one processor is further configured to execute the computer-readable instructions to display the payment request list with an SNS profile of the first user corresponding to the payment request in the payment request list.

20. The computer apparatus of claim 13, wherein the at least one processor is further configured to execute the computer-readable instructions to, based on the payment for the payment request of the first user being completed, send, to the server, a payment completion notification that comprises the transaction ID corresponding to the payment request for which the payment is completed.
